(19) United States
(12) Patent Application Publication
(10) Pub. No.: US 2013/0334207 A1
(43) Pub. Date: Dec. 19, 2013

(54) COOKING PAN

(71) Applicant: Jong Peter PARK, Pasadena, CA (US)

(72) Inventor: Jong Peter PARK, Pasadena, CA (US)

(21) Appl. No.: 13/523,773

(22) Filed: Jun. 14, 2012

(51) Int. Cl. H05B 6/12

(52) U.S. Cl. 219/621

(57) ABSTRACT

A cooking pan includes a first pan portion, an induction heating layer, a second pan portion, and a non-induction heating layer. The first pan portion has a first bottom wall and a first raised enclosing wall. The induction heating layer is provided in the first bottom wall. The second pan portion has a second bottom wall and a second raised enclosing wall. The non-induction heating layer is provided in the second bottom wall. The first pan portion and the second pan portion are symmetrically shaped with respect to bordering edge of the raised enclosing walls.

### BACKGROUND OF THE INVENTION

The present invention relates to a cooking pan.

Kitchen is a place at the center of the house in a sense, and cooking is an art for living.

Since it has to do so many things in the kitchen, a cooking pan cannot have enough of functions. If it has one more function, the cooking pan may be a bless sometimes.

Accordingly, a need for a cooking pan has been present for a long time considering the expansive demands in the everyday life. This invention is directed to solve these problems and satisfy the long-felt need.

### SUMMARY OF THE INVENTION

The present invention contrives to solve the disadvantages of the prior art.

An object of the invention is to provide a cooking pan, more specifically a cooking pan which can be used on a gas oven and an induction oven.

A cooking pan includes a first pan portion, an induction heating layer, a second pan portion, and a non-induction heating layer.

The first pan portion has a first bottom wall and a first raised enclosing wall.

The induction heating layer is provided in the first bottom wall.

The second pan portion has a second bottom wall and a second raised enclosing wall.

The non-induction heating layer is provided in the second bottom wall.

The first pan portion and the second pan portion are symmetrically shaped with respect to bordering edge of the raised enclosing walls.

The induction heating layer may comprise stainless steel that is adapted for induction heating.

The induction heating layer comprises stainless steel 430.

The non-induction heating layer may comprise forged aluminum that is adapted for flame heating.

A bottom pattern of the induction heating layer may be different from a bottom pattern of the non-induction heating layer.

A bottom color of the induction heating layer may be different from a bottom color of the non-induction heating layer.

The cooking pan may further comprise a first handle extending from a front side of the first raised enclosing wall, and a second handle extending from a front side of the second raised enclosing wall.

The cooking pan may further comprise a handle-fastening device for fastening the first and second handles together detachably.

The handle-fastening device may comprise a ring portion attached to one of the first and second handles.

The handle-fastening device may comprise a plurality of magnets provided on the first and second handles.

The cooking pan may further comprise a first detachable fastener portion and a second detachable fastener portion.

The first detachable fastener portion is disposed on a rear side of the first raised enclosing wall and extending oppositely from the first handle.

The second detachable fastener portion is disposed on a rear side of the second raised enclosing wall and extending oppositely from the second handle, and the second detachable fastener portion is configured to engage and disengage with the first detachable fastener portion.

The first and second detachable fasteners are configured to engage each other to form a closed cooking space between the first and second pan portion.

The first detachable fastener may comprise two male connectors and the second detachable fastener comprises two female connectors.

The cooking pan may further comprise: a first overflow basin disposed on the rear side of the first raised enclosing wall, and a second overflow basin disposed on the rear side of the second raised enclosing wall.

The first overflow basin may be disposed between the two male connectors and the second overflow basin is disposed between the two female connectors.

The cooking pan may further comprise an overflow hole provided through the rear side of the raised enclosing walls such that liquid overflown therethrough from inside of the cooking pan is caught and kept.

The overflow hole may comprise a first groove provided on a top edge of first raised enclosing wall and a second groove provided on a top edge of second raised enclosing wall.

The cooking pan may further comprise a pressure release provided through the raised enclosing wall.

The pressure release may be configured to release inner pressure above a predetermined pressure.

The cooking pan may further comprise a first sealing edge provided along a top edge of the first raised enclosing wall and a second sealing edge provided along a top edge of the second raised enclosing wall, so as to facilitate sealing the top edges of the first and second raised enclosing walls.

The first sealing edge may comprise a first groove edge and a first protrusion edge and the second sealing edge may comprise a second groove edge and a second protrusion edge, such that the first groove edge is fitted with the second protrusion edge and the first protrusion edge is fitted with the second groove edge.

The advantages of the present invention are: (1) the cooking pan according to the invention is convenient to use in ovens having different heating system; and (2) the cooking pan according to the invention can be used for many purposes due to its flexible design and structure.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a top plan view of a cooking pan according to an embodiment of the invention;

FIG. 2 is a bottom view of FIG. 1;

FIG. 3 is a side view of FIG. 1;

FIG. 4 is another side view of FIG. 1;

FIG. 5 is a rear view of FIG. 1;

FIG. 6 is a front view of FIG. 1;

FIG. 7 is a perspective view with a top portion opened according to another embodiment of the invention;

FIG. 8 is an enlarged perspective view showing rims according to still another embodiment of the invention;

FIG. 9 is another enlarged perspective view showing rims of FIG. 8;

FIG. 10 is still another enlarged perspective view showing rims of FIG. 8; and

FIG. 11 is a cross-sectional view along line XI-XI in FIG. 1.

### DETAILED DESCRIPTION EMBODIMENTS OF THE INVENTION

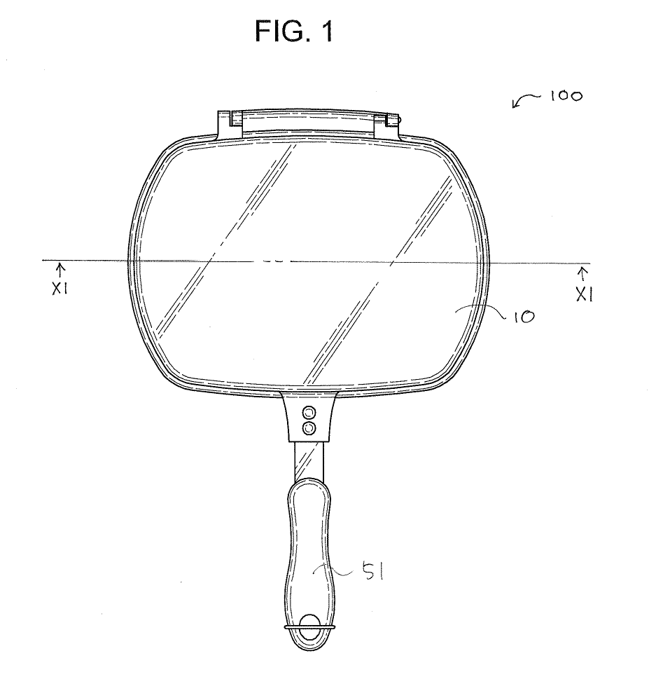

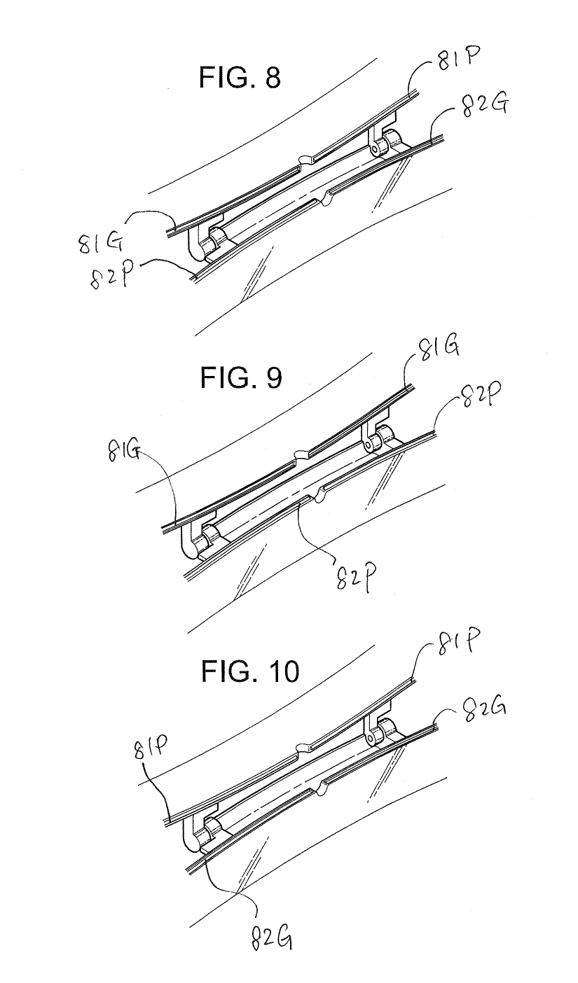

FIGS. 1-10 show cooking pans according to embodiments of the invention.

An object of the invention is to provide a cooking pan, more specifically a cooking pan which can be used on both of a gas oven and an induction oven.

An aspect of the invention provides a cooking pan 100, comprising a first pan portion 10, an induction heating layer 20, a second pan portion 30, and a non-induction heating layer 40 as shown in FIGS. 1-6.

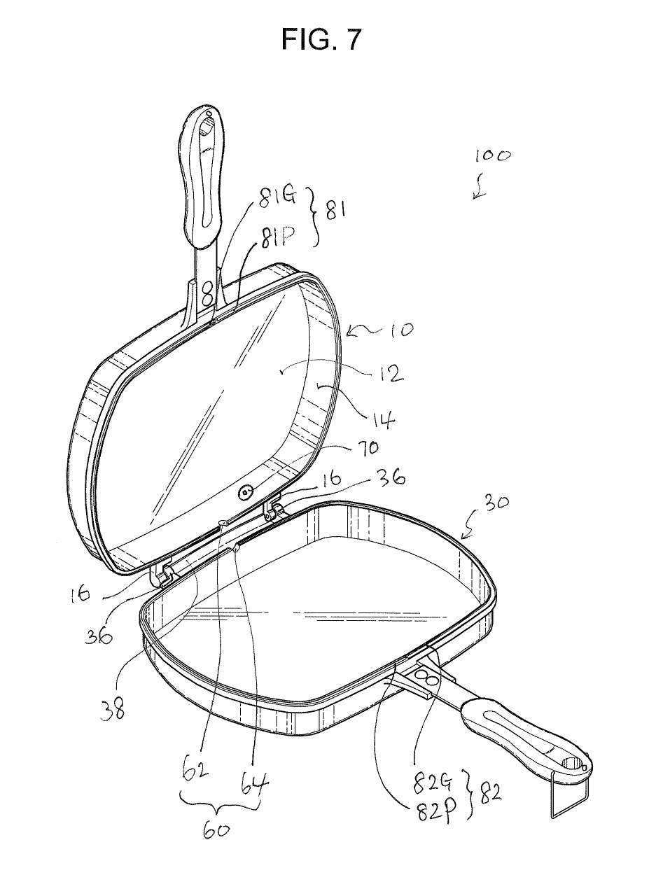

The first pan portion 10 has a first bottom wall 12 and a first raised enclosing wall 14 as shown in FIG. 7.

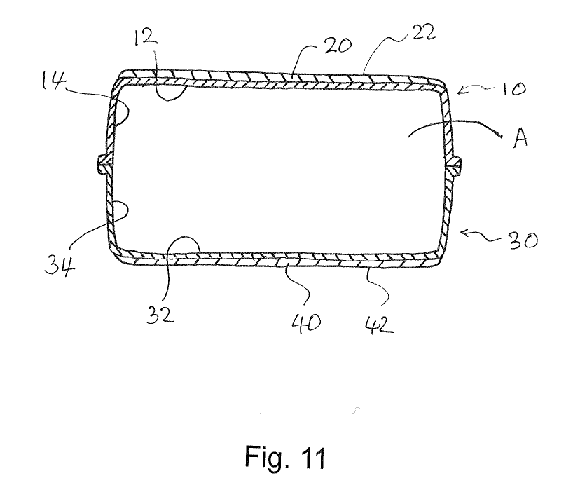

The induction heating layer 20 is provided in the first bottom wall 12 as shown in FIG. 11.

The second pan portion 30 has a second bottom wall 32 and a second raised enclosing wall 34 as shown in FIG. 7.

The non-induction heating layer 40 is provided in the second bottom wall 32 as shown in FIG. 11.

The first pan portion 10 and the second pan portion 30 are symmetrically shaped with respect to bordering edge of the raised enclosing walls 14, 34.

However, in certain embodiments of the invention, the first pan portion 10 and the second pan portion 30 may not be symmetrically shaped.

The induction heating layer 20 may comprise stainless steel that is adapted for induction heating.

The induction heating layer 20 comprises stainless steel 430.

The non-induction heating layer 40 may comprise forged aluminum that is adapted for flame heating as in a gas oven.

A bottom pattern 22 of the induction heating layer 20 may be different from a bottom pattern 42 of the non-induction heating layer 40 as shown in FIG. 11, such that a user may distinguish one from the other.

Alternatively, a bottom color of the induction heating layer 20 may be different from a bottom color of the non-induction heating layer 40. Still in certain embodiments, the bottom colors may form letters or symbols telling if it is an induction heating layer or not.

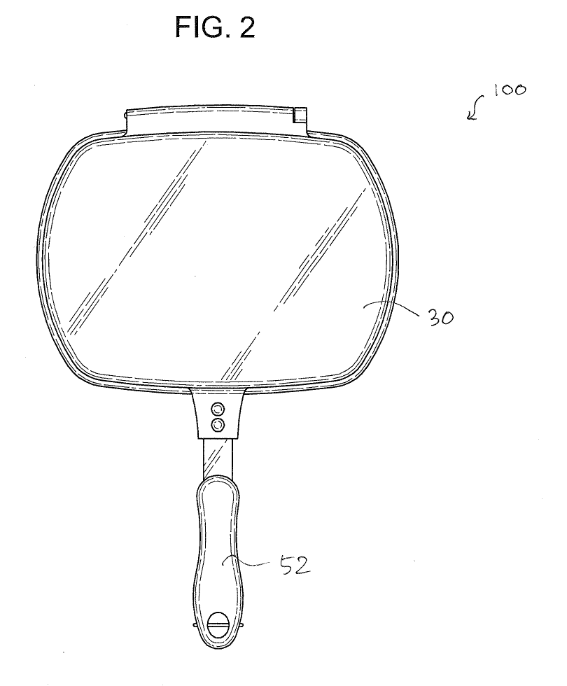

The cooking pan 100 may further comprise a first handle 51 extending from a front side of the first raised enclosing wall 14, and a second handle 52 extending from a front side of the second raised enclosing wall 34 as shown in FIGS. 1 and 2.

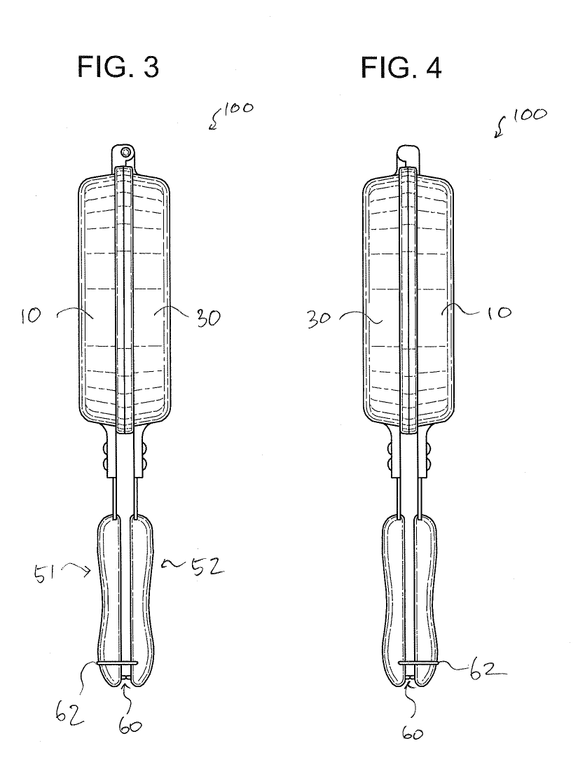

The cooking pan 100 may further comprise a handle-fastening device 60 for fastening the first and second handles 51, 52 together detachably as shown in FIGS. 3 and 4.

The handle-fastening device 60 may comprise a ring portion 62 attached to one of the first and second handles 51, 52 as shown in FIGS. 3 and 4.

The handle-fastening device 60 may comprise a plurality of magnets (not shown) provided on the first and second handles 51, 52. The handle-fastening device 60 may facilitate to seal the edges of the first and second raised enclosing wall 14, 34 and confine food inside the cooking pan 100.

The cooking pan 100 may further comprise a first detachable fastener portion 16 and a second detachable fastener portion 36 as shown in FIG. 7.

The first detachable fastener portion 16 is disposed on a rear side of the first raised enclosing wall 14 and extending oppositely from the first handle 51.

The second detachable fastener portion 36 is disposed on a rear side of the second raised enclosing wall 34 and extending oppositely from the second handle 52, and the second detachable fastener portion 36 is configured to engage and disengage with the first detachable fastener portion 16.

The first and second detachable fasteners 16, 36 are configured to engage each other to form a closed cooking space (A) between the first and second pan portion 10, 30 as shown in FIG. 11.

The first detachable fastener 16 may comprise two male connectors and the second detachable fastener 36 comprises two female connectors as shown in FIGS. 7-10.

The cooking pan 100 may further comprise: a first overflow basin (not shown) disposed on the rear side of the first raised enclosing wall 14, and a second overflow basin 38 disposed on the rear side of the second raised enclosing wall 34 as shown in FIG. 7. The first overflow basin may be formed just like the second overflow basin 38.

The first overflow basin may be disposed between the two male connectors and the second overflow basin 38 is disposed between the two female connectors.

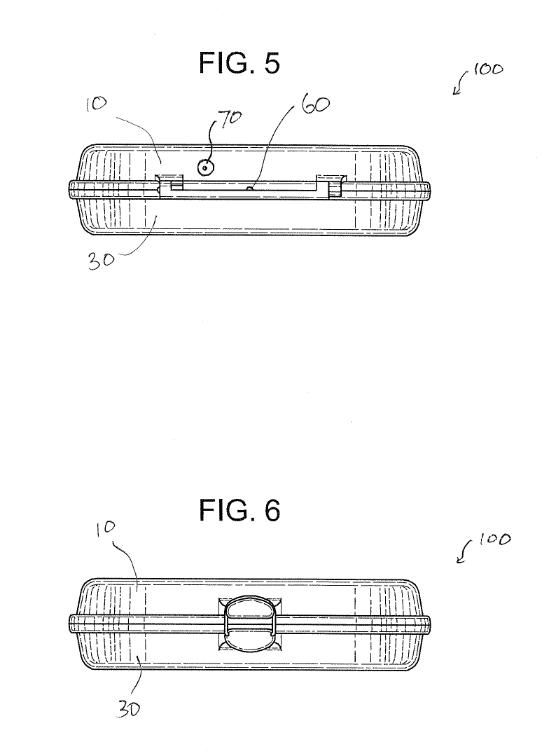

The cooking pan 100 may further comprise an overflow hole 60 provided through the rear side of the raised enclosing walls 14, 34 such that liquid overflown therethrough from inside of the cooking pan 100 is caught and kept in the overflow basin 38 as shown in FIG. 5.

The overflow hole 60 may comprise a first groove 62 provided on a top edge of first raised enclosing wall 14 and a second groove 64 provided on a top edge of second raised enclosing wall 34 as shown in FIG. 7.

The cooking pan 100 may further comprise a pressure release 70 provided through the raised enclosing wall 14, 34 as shown in FIGS. 5 and 7.

The pressure release 70 may be configured to release inner pressure above a predetermined pressure so as to prevent an explosion due to built-up high pressure.

The cooking pan 100 may further comprise a first sealing edge 81 provided along a top edge of the first raised enclosing wall 14 and a second sealing edge 82 provided along a top edge of the second raised enclosing wall 34, so as to facilitate sealing the top edges of the first and second raised enclosing walls 14, 34 as shown in FIGS. 7-10.

The first sealing edge 81 may comprise a first groove edge 81G and a first protrusion edge 81P and the second sealing edge 82 may comprise a second groove edge 82G and a second protrusion edge 82P, such that the first groove edge 81G is fitted with the second protrusion edge 82P and the first protrusion edge 81P is fitted with the second groove edge 82G as shown in FIGS. 7-10. In certain embodiments, the first sealing edge 81 may have the first groove (protrusion) edges 81G (81P) only and the second sealing edge 82 may have the second protrusion (groove) edges 82P (82G) only.

As shown in FIGS. 7 and 11, the depth of the first and second pan portions 10, 30, that is the height of the first and second raised enclosing walls 14, 34 can be varied. The closed cooking space (A) may be big enough to hold a large chicken, for example.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A cooking pan comprising:
a first pan portion having a first bottom wall and a first raised enclosing wall;
an induction heating layer provided in the first bottom wall;
a second pan portion having a second bottom wall and a second raised enclosing wall; and
a non-induction heating layer provided in the second bottom wall,
wherein the first pan portion and the second pan portion are symmetrically shaped with respect to bordering edge of the raised enclosing, walls.

2. The cooking pan of claim 1, wherein the induction heating layer comprises stainless steel that is adapted for induction heating.

3. The cooking pan of claim 2, wherein the induction heating layer comprises stainless steel 430.

4. The cooking pan of claim 1, wherein the non-induction heating layer comprises forged aluminum that is adapted for flame heating.

5. The cooking pan of claim 1, wherein a bottom pattern of the induction heating layer is different from a bottom pattern of the non-induction heating layer.

6. The cooking pan of claim 1, wherein a bottom color of the induction heating layer is different from a bottom color of the non-induction heating layer.

7. The cooking pan of claim 1, further comprising:
a first handle extending from a front side of the first raised enclosing wall; and
a second handle extending from a front side of the second raised enclosing wall.

8. The cooking pan of claim 7, further comprising a handle-fastening device for fastening the first and second handles together detachably.

9. The cooking pan of claim 8, wherein the handle-fastening device comprises a ring portion attached to one of the first and second handles.

10. The cooking pan of claim 8, wherein the handle-fastening device comprises a plurality of magnets provided on the first and second handles.

11. The cooking pan of claim 7, further comprising:
a first detachable fastener portion disposed on a rear side of the first raised enclosing wall and extending oppositely from the first handle; and
a second detachable fastener portion disposed on a rear side of the second raised enclosing wall and extending oppositely from the second handle, wherein the second detachable fastener portion is configured to engage and disengage with the first detachable fastener portion,
wherein the first and second detachable fasteners are configured to engage each other to form a closed cooking space between the first and second pan portion.

12. The cooking pan of claim 11, wherein the first detachable fastener comprises two male connectors and the second detachable fastener comprises two female connectors.

13. The cooking pan of claim 12, further comprising:
a first overflow basin disposed on the rear side of the first raised enclosing wall; and
a second overflow basin disposed on the rear side of the second raised enclosing wall.

14. The cooking pan of claim 13, wherein the first overflow basin is disposed between the two male connectors and the second overflow basin is disposed between the two female connectors.

15. The cooking pan of claim 1, further comprising an overflow hole provided through the rear, side of the raised enclosing walls such that liquid overflown therethrough from inside of the cooking pan is caught and kept.

16. The cooking pan of claim 15, wherein the overflow hole comprises a first groove provided on a top edge of first raised enclosing wall and a second groove provided on a top edge of second raised enclosing wall.

17. The cooking pan of claim 1, further comprising a pressure release provided through the raised enclosing wall.

18. The cooking pan of claim 17, wherein the pressure release is configured to release inner pressure above a predetermined pressure.

19. The cooking pan of claim 1, further comprising a first sealing edge provided along a top edge of the first raised enclosing wall and a second sealing edge provided along a top edge of the second raised enclosing wall, so as to facilitate sealing the top edges of the first and second raised enclosing walls.

20. The cooking pan of claim 19, wherein the first sealing edge comprises a first groove edge and a first protrusion edge and the second sealing edge comprises a second groove edge and a second protrusion edge, such that the first groove edge is fitted with the second protrusion edge and the first protrusion edge is fitted with the second groove edge.
